(19) United States
(12) Patent Application Publication
(10) Pub. No.: US 2017/0018010 A1
(43) Pub. Date: Jan. 19, 2017

(54) ADVERTISEMENT-PROVIDING DEVICE USING ELECTRONIC PEN, AND ADVERTISING METHOD THEREFOR

(71) Applicants: Myeong Hwan LEE, Gyeonggi-do (KR); Tae Min SONG, Gyeonggi-do (KR)

(72) Inventors: Myeong Hwan LEE, Gyeonggi-do (KR); Tae Min SONG, Gyeonggi-do (KR)

(21) Appl. No.: 15/124,522

(22) PCT Filed: Mar. 11, 2015
(86) PCT No.: PCT/KR2015/002334

§ 371 Date: Sep. 8, 2016

(30) Foreign Application Priority Data
Mar. 11, 2014 (KR) 10-2014-0028574

(51) Int. Cl. G06Q 30/02; G06F 17/30

(52) U.S. Cl. CPC G06Q 30/0277; G06F 17/30867

(57) ABSTRACT

An advertisement-providing device using an electronic pen according to one embodiment of the present invention comprises: a receiving unit for receiving pattern information sensed by an electronic pen on a recording medium on which a pattern is formed, and identification information of the electronic pen; a writing data conversion unit for converting the pattern information to writing data; an advertisement information extraction unit for extracting advertisement information from the identification information; a storage unit for storing the writing data and the advertisement information; and a communication unit for transmitting, to a user terminal, the writing data and advertisement information corresponding to the writing data.

### TECHNICAL FIELD

The present disclosure relates to an advertisement, and more particularly, to an advertisement-providing device and an advertising method thereof.

### BACKGROUND ART

An electronic pen is a new-concept pen in which analog and digital are combined. When letters are written on a paper using the electronic pen, written information is transmitted to a computer and may be managed in the form of an image file. A document written with a normal pen may also be managed in the form of an image file when scanned by a scanner (an electronic color separation apparatus). However, a document written with an electronic pen has advantages in that a scanning process is not required and that the document can be easily managed through a separate program.

There are attempts to share an image file including handwriting written using an electronic pen with another person. For example, an e-book created with handwriting may be shared with another person, or a document created with handwriting may be shared through a social network service (SNS). A document created with handwriting may express greater sincerity of a creator compared to a document created with a digital font and may effectively satisfy a reader's emotion.

Meanwhile, there are demands for utilizing handwriting written using an electronic pen in an advertisement.

### DISCLOSURE

### Technical Problem

The present disclosure is directed to providing an advertisement-providing device using an electronic pen and an advertising method thereof.

### Technical Solution

According to an embodiment of the present disclosure, an advertisement-providing device using an electronic pen includes a receiving unit that receives pattern information detected by an electronic pen on a recording medium on which a pattern is formed and identification information of the electronic pen, a writing data conversion unit that converts the pattern information into writing data, an advertisement information extraction unit that extracts advertisement information from the identification information, a storage unit that stores the writing data and the advertisement information, and a communication unit that transmits the writing data and advertisement information corresponding to the writing data to a user terminal.

The writing data may include an image file including handwriting recorded on the recording medium by the electronic pen.

The advertisement information may include one or more of a video advertisement, an advertisement through a web page, an image advertisement, and a voice advertisement.

The advertisement information may further include information on a position at which the image advertisement is posted.

The advertisement information may further include information on a time for which the voice advertisement is output.

The storage unit may store the writing data, the advertisement information corresponding to the writing data, and a keyword corresponding to the writing data as a group.

The advertisement-providing device may further include a search unit that searches for writing data and advertisement information grouped with a keyword.

The advertisement-providing device may further include an advertisement information storage unit that stores advertisement information for each piece of identification information of the electronic pen, and the advertisement information extraction unit may extract the advertisement information from the advertisement information storage unit.

According to an embodiment of the present disclosure, an advertising method using an electronic pen of an advertisement-providing device includes receiving pattern information detected by the electronic pen on a recording medium on which a pattern is formed and identification information of the electronic pen, converting the pattern information into writing data, extracting advertisement information from the identification information, storing the writing data and the advertisement information, and transmitting the writing data and the advertisement information to a user terminal.

### Advantageous Effects

According to an embodiment of the present disclosure, an image file created with handwriting using an electronic pen may be utilized in an advertisement. Accordingly, an effect of a corporate advertisement can be improved.

### DESCRIPTION OF DRAWINGS

FIG. 1 is a block diagram illustrating an advertisement system according to an embodiment of the present disclosure.

FIG. 2 is an example of an electronic pen according to an embodiment of the present disclosure.

FIG. 3 is an example of an electronic pen and a recording medium according to an embodiment of the present disclosure.

FIGS. 4 and 5 are views for describing a dot pattern formed on a recording medium according to an embodiment of the present disclosure.

FIG. 6 is a block diagram of an advertisement-providing device according to an embodiment of the present disclosure.

FIG. 7 is a block diagram of a user terminal according to an embodiment of the present disclosure.

FIG. 8 illustrates an example in which an advertisement information storage unit of the advertisement-providing device stores advertisement information for each piece of identification information of the electronic pen according to an embodiment of the present disclosure.

FIG. 9 illustrates an example in which a storage unit of the advertisement-providing device stores writing data and advertisement information according to an embodiment of the present disclosure.

FIG. 10 is a flowchart illustrating an advertising method of an advertisement system according to an embodiment of the present disclosure.

### MODES OF THE INVENTION

Since various modifications may be made to the present disclosure and the present disclosure may have various embodiments, particular embodiments will be illustrated in the drawings and described. However, this does not limit the present disclosure to the particular embodiments, and all modifications, equivalents, and substitutes included in the spirit and scope of the present disclosure should be construed as belonging to the present disclosure.

Terms including ordinal numbers such as first and second may be used to describe various elements, but the elements are not limited by the terms. The terms are only used for the purpose of distinguishing one element from another element. For example, a second element may be referred to as a first element while not departing from the scope of the present disclosure, and likewise, a first element may also be referred to as a second element. The term and/or includes a combination of a plurality of related described items or any one item among the plurality of related described items.

When it is mentioned that a certain element is “connected” or “linked” to another element, although the certain element may be directly connected or linked to the other element, it should be understood that another element may exist therebetween. On the other hand, when it is mentioned that a certain element is “directly connected” or “directly linked” to another element, it should be understood that other elements do not exist therebetween.

Terms used in the application are merely used to describe particular embodiments and are not intended to limit the present disclosure. A singular expression includes a plural expression unless the context clearly indicates otherwise. In the application, terms such as “include” or “have” should be understood as designating that features, number, steps, operations, elements, parts, or combinations thereof exist and not as precluding the existence of or the possibility of adding one or more other features, numbers, steps, operations, elements, parts, or combinations thereof.

Unless otherwise defined, all terms including technical or scientific terms used herein have the same meaning as commonly understood by one of ordinary skill in the art to which the disclosure pertains. Terms, such as those defined in commonly used dictionaries, should be construed as having a meaning that is consistent with their meaning in the context of the relevant art and are not to be construed in an idealized or overly formal sense unless expressly so defined herein.

Hereinafter, an embodiment will be described in detail with reference to the accompanying drawings while like reference numerals will be given to the same or corresponding elements regardless of signs in the drawings and overlapping descriptions thereof will be omitted.

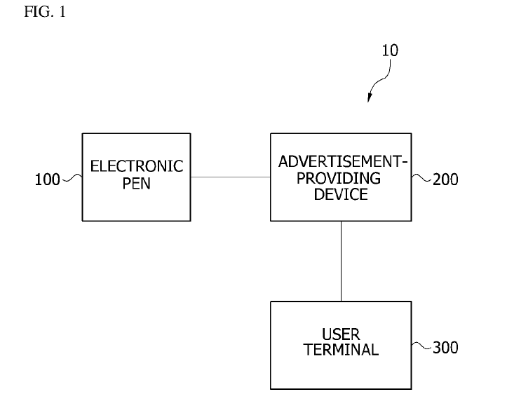

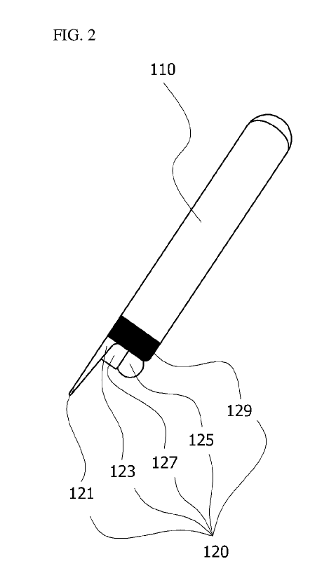

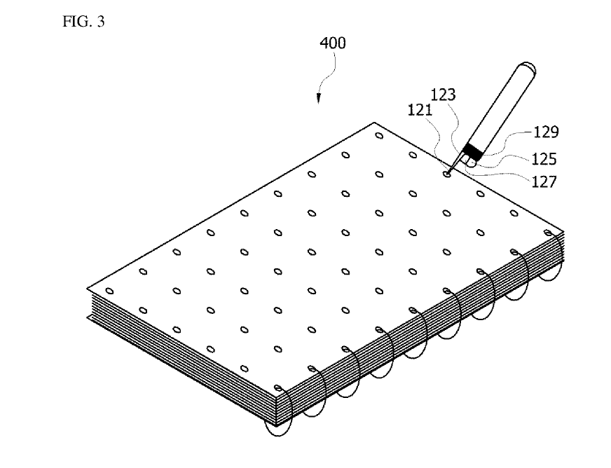

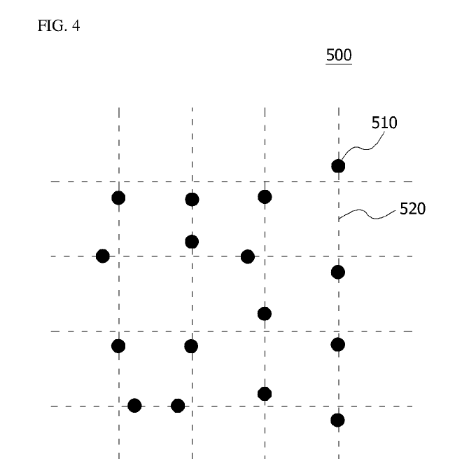

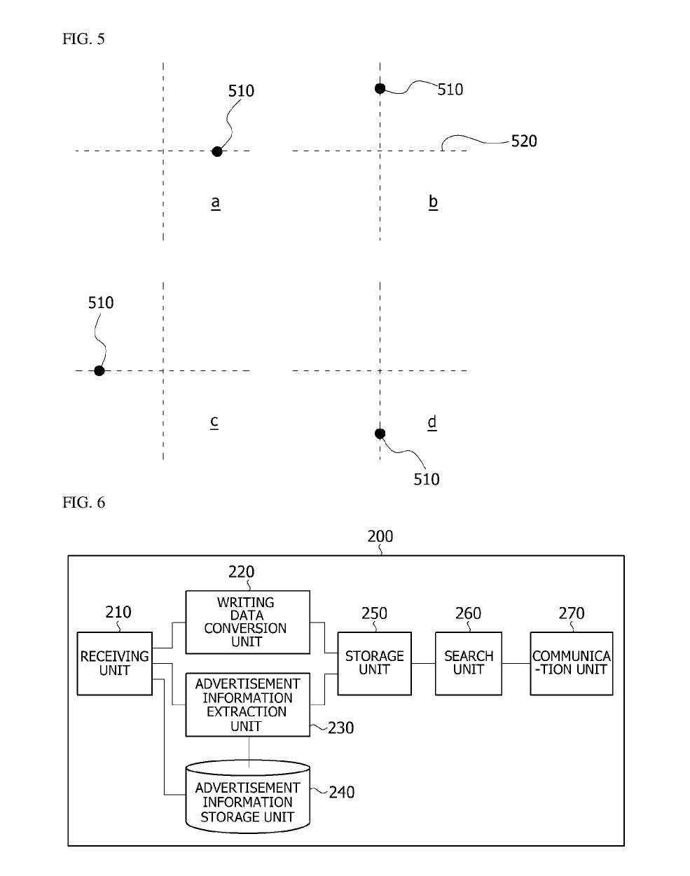

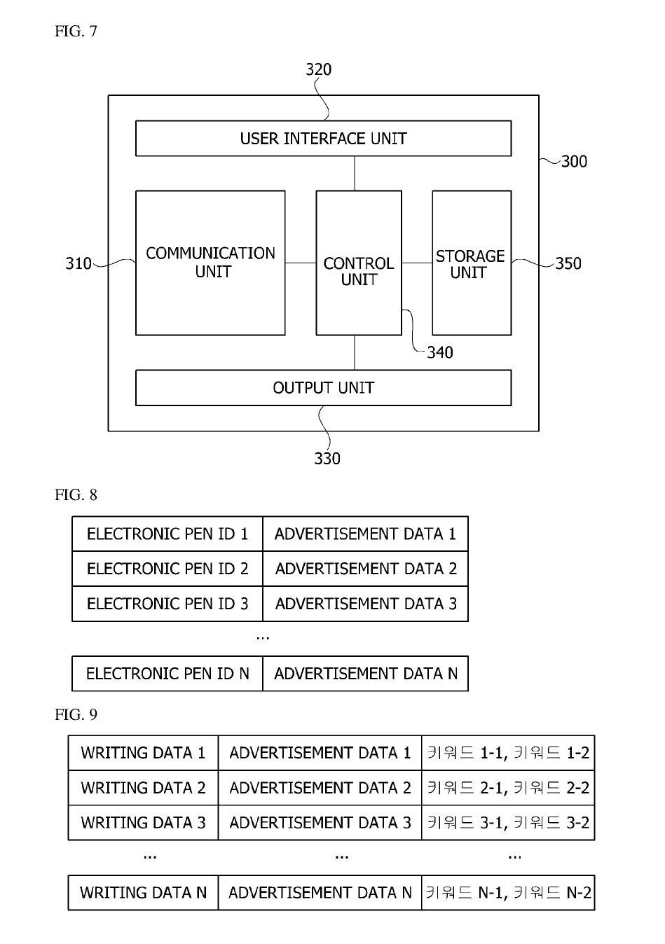

FIG. 1 is a block diagram illustrating an advertisement system according to an embodiment of the present disclosure; FIG. 2 is an example of an electronic pen according to an embodiment of the present disclosure; FIG. 3 is an example of an electronic pen and a recording medium according to an embodiment of the present disclosure; FIGS. 4 and 5 are views for describing a dot pattern formed on a recording medium according to an embodiment of the present disclosure; FIG. 6 is a block diagram of an advertisement-providing device according to an embodiment of the present disclosure; and FIG. 7 is a block diagram of a user terminal according to an embodiment of the present disclosure.

Referring to FIG. 1, an advertisement system 10 includes an electronic pen 100, an advertisement-providing device 200, and a user terminal 300.

The electronic pen 100 detects pattern information on a recording medium on which a pattern is formed. Here, the pattern is a means for determining positions on the recording medium and may be formed as various shapes such as a dot shape, a linear shape, a diagonal shape, a curved shape, and a ring shape. Although a dot-shaped dot pattern is described herein as an example for convenience of description, this is merely illustrative, and the present disclosure is not limited thereto. Positions on the recording medium may be identified using the pattern information detected by the electronic pen 100.

The advertisement-providing device 200 converts pattern information received from the electronic pen 100 into writing data. Here, the pattern information may refer to the pattern information itself detected by the electronic pen 100 or position information (e.g., absolute coordinates) extracted from the pattern information. For example, after detecting the pattern information on the recording medium, the electronic pen 100 may extract position information from the pattern information and transmit the position information to the advertisement-providing device 200. In another example, the electronic pen 100 may transmit the pattern information on the recording medium to the advertisement-providing device 200, and the advertisement-providing device 200 may extract position information from the pattern information.

In addition, the advertisement-providing device 200 extracts advertisement information from identification information of the electronic pen 100 received from the electronic pen 100. Also, the advertisement-providing device 200 stores the converted writing data and the extracted advertisement information.

The advertisement-providing device 200 transmits stored writing data and advertisement information corresponding thereto to the user terminal 300 via a social network service (SNS).

When the user terminal 300 transmits a search request including a keyword to the advertisement-providing device 200, the advertisement-providing device 200 may search for writing data matching the keyword and transmit the found writing data and advertisement information corresponding thereto to the user terminal 300.

The user terminal 300 accesses a network and outputs a result received from the advertisement-providing device 200.

Referring to FIGS. 2 and 3, the electronic pen 100 includes a body unit 110, a writing unit 120 provided at one end of the body unit 110 to detect pattern information on a recording medium on which a dot pattern is formed, a storage unit (not illustrated) included in the body unit 110 to store identification information of the electronic pen, and a communication unit (not illustrated) included in the body unit 110.

The body unit 110 may be formed including one of a composite resin such as an acrylonitrile butadiene styrene (ABS) copolymer and polycarbonate (PC), a synthetic resin such as polypropylene (PP) and polyphenylene sulfide (PPS), a polymethyl methacrylate (PMMA) synthetic resin, a polystyrene (PS) synthetic resin, glass, metals, and a mixture selected therefrom.

The body unit 110 may be formed to have a uniform diameter from top to bottom or to have a large diameter at the top and a small diameter at the bottom, and a cover (not illustrated) may be formed at both end portions thereof.

The writing unit 120 includes a pen tip unit 121 that is able to record on a recording medium 400, a pressure sensor 123 that generates information on a pen pressure applied to the pen tip unit 121, an infrared light source 125 that outputs infrared rays on the recording medium 400, an infrared sensor 127 that detects infrared rays scattering on the recording medium 400, and a detection unit 129 that uses the detected infrared rays to detect pattern information.

The pen tip unit 121 may be formed in the form of a pen tip protruding outward from one end of the body unit 110.

The pressure sensor 123 may be adjacent to the pen tip unit 121 and may detect a pressure applied to the pen tip unit 121. When contact between the pen tip unit 121 and the recording medium 400 occurs, the pressure sensor 123 may generate pen pressure information by calculating a pressure proportional to a force applied to the pen tip unit 121 as a numerical value.

The infrared light source 125 projects infrared rays when the pen tip unit 121 is in contact with the recording medium 400 or approaches within a predetermined distance or less of the recording medium 400.

The infrared sensor 127 is adjacent to the pen tip unit 121 and detects infrared rays scattering on the recording medium 400.

The detection unit 129 uses infrared rays detected by the infrared sensor 127 to detect a dot pattern on the recording medium 400.

Meanwhile, the recording medium 400 may include a paper printed with a pattern, e.g., a dot pattern. The recording medium 400 may be, for example, a book, a diary printed with a dot pattern.

The dot pattern formed on the recording medium according to an embodiment of the present disclosure will be described in detail with reference to FIGS. 4 and 5.

Referring to FIG. 4, a dot pattern 500 may include a plurality of marks 510, and the marks 510 may be formed at predetermined intervals with respect to intersection points of virtual grid lines 520. The marks 510 may provide pattern information by pattern values determined according to positions at which the marks 510 are formed with respect to the intersection points of the virtual grid lines 520.

The marks 510 may be formed using infrared absorbing ink including, for example, one of a phthalocyanine-based compound, a naphthalocyanine-based compound, an aminium-based compound, and a mixture selected therefrom. Accordingly, the infrared sensor 127 may detect infrared rays scattering at portions where the marks 510 are not formed, and the detection unit 129 may calculate pattern information according to values of the marks 510 when thirty-six marks 510 with six marks 510 disposed at each row and column of the grid lines 520 at a size of 6×6 are recognized using the detected infrared rays.

The marks 510 are formed at predetermined intervals with respect to the intersection points of the virtual grid lines 520, and each of the marks 510 has a value. The value of each of the marks 510 may be formed of a combination of two or more different numbers.

The marks 510 may be formed in various shapes including a circular shape, an elliptical shape, a polygonal shape, a linear shape, etc.

Referring to FIG. 5, the marks 510 may be present at four different positions according to relations with the intersection points of the virtual grid lines 520. The value of the mark 510 may be represented as “1” when the mark 510 is disposed at the right of the intersection point as shown in a, the value of the mark 510 may be represented as “2” when the mark 510 is disposed above the intersection point as shown in b, the value of the mark 510 may be represented as “3” when the mark 510 is disposed at the left of the intersection point as shown in c, and the value of the mark 510 may be represented as “4” when the mark 510 is disposed below the intersection point as shown in d. In this way, the pattern information may be detected according to positions of the marks 510 with respect to the intersection points of the virtual grid lines 520.

In addition, the marks 510 may also be formed in a diagonal direction instead of being formed on the virtual grid lines 520, and position information may be provided by a plurality of marks 510 formed at intersection points of one virtual grid line 520. In this case, each of the values of the marks 510 may be expressed with random coordinates including an x-coordinate and a y-coordinate, and the pattern information may be provided from the values of the marks 510 expressed with the coordinates.

The virtual grid lines 520 may be horizontally and vertically formed at predetermined intervals. A distance between the grid lines 520 may be 250 μm to 300 μm, and the marks 510 may be formed at points spaced apart by ⅛ to ¼ with respect to the intersection points of the virtual grid lines 520. Alternatively, two or more marks 510 may also be related and formed with respect to the intersection points of the virtual grid lines 520.

According to an embodiment of the present disclosure, the pattern information recognized by the electronic pen 100 and identification information pre-stored in the electronic pen 100 may be transmitted to the advertisement-providing device 200. In addition, the advertisement-providing device 200 may use the pattern information recognized by the electronic pen 100 to convert writing data and use the identification information of the electronic pen 100 to extract advertisement information.

Referring to FIG. 6, the advertisement-providing device 200 includes a receiving unit 210, a writing data conversion unit 220, an advertisement information extraction unit 230, an advertisement information storage unit 240, a storage unit 250, a search unit 260, and a communication unit 270.

The receiving unit 210 may receive pattern information and identification information from the electronic pen 100. For example, the receiving unit 210 may communicate with the electronic pen 100 by wire or wirelessly and may receive pattern information detected by the electronic pen 100 according to positions of the marks 510 with respect to the intersection points of the virtual grid lines 520. In addition, the receiving unit 210 may receive identification information, e.g., identity (ID) information, of the electronic pen 100 stored in the electronic pen 100. The identification information of the electronic pen 100 may be received together with the pattern information. The identification information of the electronic pen 100 may also be received first, and then the pattern information may be received. Here, the pattern information may be processed according to previously received identification information before new identification information is received.

In addition, the writing data conversion unit 220 extracts position information (e.g., absolute coordinates) from the received pattern information. Here, the position information may include, for example, information on a position at which the electronic pen 100 begins to be in contact with the recording medium 400, information on positions at which the electronic pen 100 moves while continuously being in contact with the recording medium 400, information on a position at which the electronic pen 100 has lastly been in contact with the recording medium 400, etc. When the electronic pen 100 extracts position information from the pattern information and transmits the position information, a process of extracting the position information by the writing data conversion unit 220 may be omitted.

In addition, the writing data conversion unit 220 converts the extracted position information into writing data. Here, the writing data may be an image file including handwriting recorded on the recording medium 400 by the electronic pen 100. Here, the handwriting may be expressed on a background image. The background image may be a background image on the recording medium 400 on which handwriting is written on by the electronic pen 100. For this, information on the background image may be pre-stored in the advertisement-providing device 200 and may be extracted from the pattern information transmitted by the electronic pen 100.

Meanwhile, the advertisement information extraction unit 230 uses the identification information received from the electronic pen 100 to extract advertisement information. For this, the advertisement-providing device 200 may further include an advertisement information storage unit 240 that stores advertisement information for each piece of identification information of the electronic pen 100. The advertisement information extraction unit 230 may extract advertisement information from the advertisement information storage unit 240. FIG. 8 illustrates an example in which the advertisement information storage unit 240 of the advertisement-providing device 200 stores advertisement information for each piece of identification information of the electronic pen 100 according to an embodiment of the present disclosure. As illustrated in FIG. 8, identification information of the electronic pen 100 and advertisement information corresponding thereto may be stored as pairs.

Here, advertisement information may include one or more of information on a video advertisement, information on an advertisement through a web page, information on an image advertisement, and information on a voice advertisement. Here, the video advertisement may include multimedia content for advertising a corporation or a product. The image advertisement may include a drawing or a phrase for advertising a corporation or a product. In addition, the voice advertisement may include a voice for advertising a corporation or a product.

When the advertisement information includes information on a video advertisement, the advertisement information may include information on video content, a link address of the video content, and a video exposure time.

When the advertisement information includes information on an advertisement through a web page, the advertisement information may include information such as a link address of the web page and a web page exposure time.

When the advertisement information includes information on an image advisement, the advertisement information may further include information on a position at which the image advertisement is posted.

When the advertisement information includes a voice advertisement, the advertisement information may further include information on a time for which the voice advertisement is output.

Meanwhile, the storage unit 250 stores the writing data converted by the writing data conversion unit 220 and the advertisement information extracted by the advertisement information extraction unit 230. FIG. 9 illustrates an example in which the storage unit 250 of the advertisement-providing device 200 stores writing data and advertisement information according to an embodiment of the present disclosure. As illustrated in FIG. 9, writing data and advertisement information corresponding thereto may be stored by being paired with each other. In addition, a keyword included in the writing data may also be stored by being paired with the writing data. The keyword may be pre-designated by a creator. The keyword may also be extracted in advance from the writing data by the advertisement-providing device 200. Although not illustrated, writing data and advertisement information corresponding thereto may also be stored by being paired with a background image. The background image may be extracted from the pattern information received from the electronic pen 100. Writing data and a background image stored by being paired with each other may be extracted from the same pattern information. The writing data and the background image may be separately stored or may be stored as a single image file by the writing data being combined with the background image.

Meanwhile, the communication unit 270 communicates with the user terminal 300 and transmits writing data and advertisement information stored in the storage unit 250 to the user terminal 300. Here, writing data and advertisement information corresponding thereto may be provided to the user terminal 300 through a SNS or a search of a user. Here, the communication unit 270 may separately transmit writing data and advertisement information corresponding thereto to the user terminal 300, and the writing data and the advertisement information may be combined and output by the user terminal 300. Alternatively, a signal processing unit (not illustrated) of the advertisement-providing device 200 may combine the writing data and the advertisement information corresponding thereto in advance and may transmit data in which the writing data and the advertisement information are combined to the user terminal 300. Here, the combined data may be an image advertisement posted on an image file including handwriting. Alternatively, the combined data may be a voice advertisement added to an image file including handwriting.

When writing data and advertisement information corresponding thereto are provided through a search of the user, the search unit 260 searches for writing data paired with a keyword which has been requested to be searched for from the user terminal 300 and extracts the found writing data and advertisement information paired therewith. For example, when the user terminal 300 has input “singer OOO” as a keyword and requested that the keyword be searched for, the search unit 260 may search for pre-stored writing data with “singer OOO” as a keyword and may extract the found writing data and advertisement information corresponding thereto.

Although not illustrated, the advertisement-providing device 200 may be separated into an information processing device and an advertisement server. That is, the information processing device may perform some functions of the elements of the advertisement-providing device 200, and the advertisement server may perform the remaining functions of the advertisement-providing device 200. In addition, the information processing device and the advertisement server may communicate by wire or wirelessly.

For example, the information processing device may perform functions of the receiving unit 210, the writing data conversion unit 220, and the advertisement information extraction unit 230 of the advertisement-providing device 200, and the advertisement server may include the advertisement information storage unit 240, the storage unit 250, the search unit 260, and the communication unit 270 of the advertisement-providing device 200. For this, the information processing device may further include a combining unit that combines writing data converted by the writing data conversion unit 220 with advertisement information extracted by the advertisement information extraction unit 230. In addition, the advertisement information extraction unit 230 of the information processing device and the advertisement information storage unit 240 of the advertisement server may transmit and receive data directly or indirectly.

In another example, the information processing device may perform functions of the receiving unit 210 and the writing data conversion unit 220 of the advertisement-providing device 200, and the advertisement server may include the advertisement information extraction unit 230, the advertisement information storage unit 240, the storage unit 250, the search unit 260, and the communication unit 270.

Here, the information processing device may be, for example, a personal computer (PC), a laptop computer, a smartphone, a tablet PC, etc.

Referring to FIG. 7, the user terminal 300 may be a PC, a laptop computer, a smartphone, a tablet PC, etc.

The user terminal 300 includes a communication unit 310, a user interface unit 320, an output unit 330, a control unit 340, and a storage unit 350. However, not all of the illustrated elements are essential. The user terminal may also be implemented with more or less elements than the number of illustrated elements.

The communication unit 310 may include a mobile communication module and a wireless Internet module, and the modules may be entirely or partially integrated into a single module.

The mobile communication module transmits and receives wireless signals to and from one or more of a base station, an external terminal, and a server in a mobile communication network. The wireless signals may include various forms of data according to voice call signals, video call signals, or transmission and reception of text messages or multimedia messages.

The wireless Internet module refers to a module for wireless Internet access and may be embedded or externally provided. A wireless local area network (WLAN), wireless fidelity (Wi-Fi), wireless broadband (Wibro), Worldwide Interoperability for Micro-wave Access (WiMAX), High Speed Downlink Packet Access (HSDPA), etc. may be used as a wireless Internet technology.

The user interface unit 320 receives data or information for controlling an operation of the terminal from the user. The user interface unit 320 may be a key pad, a dome switch, a touch pad (hydrostatic or electrostatic), a jog wheel, a jog switch, a microphone, etc.

The output unit 330 displays information processed in the user terminal 300 in various forms of signals (e.g., sound signals and visual signals). The output unit 330 may be, for example, a liquid crystal display (LCD), a light emission diode (LED) display, an organic LED (OLED) display, a speaker, etc.

The control unit 340 controls an overall operation of the user terminal 300. For example, the control unit 340 performs overall controlling and processing associated with voice calls, data communication, video calls, etc.

The storage unit 350 stores a program for operating the control unit 340 and temporarily stores data being input thereto and output therefrom. The user terminal 300 may also operate in association with a web storage that performs a storing function of the storage unit 350 on the Internet.

According to an embodiment of the present disclosure, when the user interface unit 320 of the user terminal 300 receives a predetermined keyword from the user, the communication unit 310 requests that the advertisement-providing device 200 search for the corresponding keyword. When the communication unit 310 receives writing data and advertisement information related to the predetermined keyword from the advertisement-providing device 200, the output unit 330 outputs the received writing data and advertisement information.

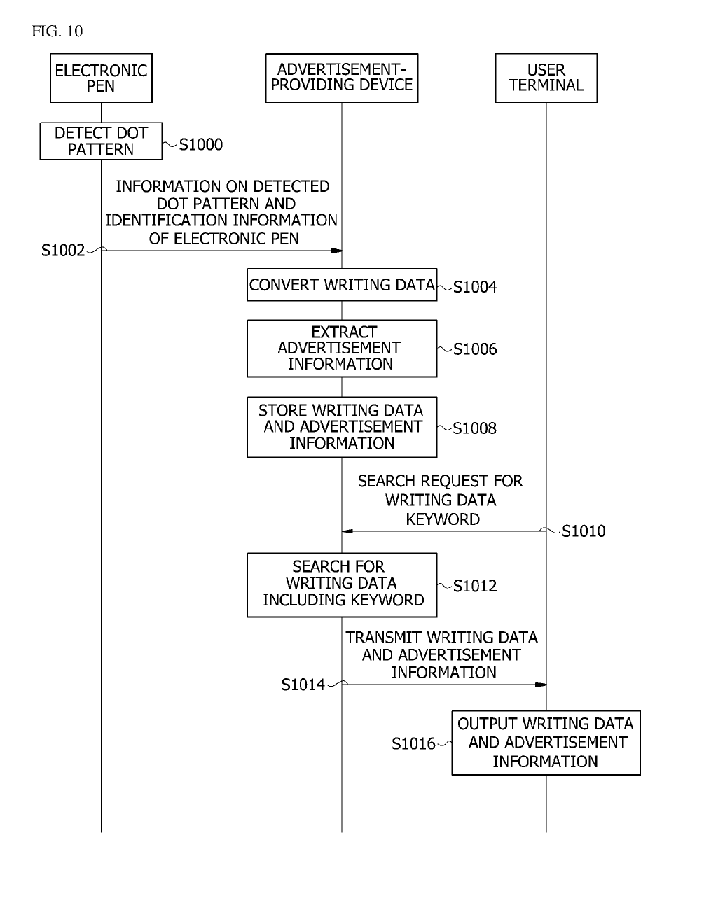

FIG. 10 is a flowchart illustrating an advertising method of an advertisement system according to an embodiment of the present disclosure. Descriptions overlapping those with reference to FIGS. 1 to 9 will be omitted.

Referring to FIG. 10, the electronic pen 100 detects a dot pattern on the recording medium 400 (S1000) and transmits pattern information on the detected dot patterns and identification information of the electronic pen 100 to the advertisement-providing device 200 (S1002).

The advertisement-providing device 200 uses the pattern information received from the electronic pen 100 to extract position information and converts the extracted position information into writing data (S1004). When the electronic pen 100 extracts the position information from the pattern information and then transmits the position information to the advertisement-providing device 200, a process of extracting the position information by the advertisement-providing device 200 may also be omitted.

In addition, the advertisement-providing device 200 uses the identification information received from the electronic pen 100 to extract advertisement information (S1006).

The advertisement-providing device 200 stores the converted handwriting information and the extracted advertisement information (S1008).

Meanwhile, when the user terminal 300 has requested that a predetermined keyword be searched for (S1010), the advertisement-providing device 200 searches for writing data including the corresponding keyword (S1012) and transmits the found writing data and advertisement information corresponding thereto to the user terminal 300 (S1014). In addition, the user terminal 300 outputs the writing data and advertisement information received from the advertisement-providing device 200 (S1016). When the writing data and the advertisement information are provided to the user terminal 300 through a SNS, a search process (i.e., S1010, 1012) may also be omitted.

In this way, an image file including handwriting recorded by the electronic pen 100 may be exposed together with advertisement information pre-stored for each electronic pen 100.

The term “-unit” used herein refers to a software element or a hardware element such as a field-programmable gate array (FPGA) and an application-specific integrated circuit (ASIC), and a “-unit” plays a certain role. However, a “-unit” is not limited to software or hardware elements. A “-unit” may be configured to be in an addressable recording medium or may also be configured to be reproduced by one or more processors. Consequently, for example, a “-unit” include an element such as a software element, an object-oriented software element, a class element, and a task element, a process, a function, a feature, a procedure, a sub-routine, a segment of a program code, a driver, firmware, a microcode, a circuit, data, a database, a data structure, a table, an array, and a variable. Functions provided in elements and “units” may be combined into a smaller number of elements and “-units” or may be further separated into a larger number of elements and “-units”. In addition, the elements and the “-units” may also be implemented to reproduce one or more central processing units (CPUs) within a device or a security multimedia card.

Although descriptions have been given above with reference to an exemplary embodiment of the present disclosure, those of ordinary skill in the art should understand that various modifications and changes may be made to the present disclosure within the scope not departing from the spirit and area of the present disclosure to be described in the claims below.

1. An advertisement-providing device using an electronic pen, the advertisement-providing device comprising:
a receiving unit configured to receive pattern information detected by the electronic pen on a recording medium on which a pattern is formed and identification information of the electronic pen;
a writing data conversion unit configured to convert the pattern information into writing data;
an advertisement information extraction unit configured to extract advertisement information from the identification information;
a storage unit configured to store the writing data and the advertisement information; and
a communication unit configured to transmit the writing data and advertisement information corresponding to the writing data to a user terminal

2. The advertisement-providing device of claim 1, wherein the writing data includes an image file including handwriting recorded on the recording medium by the electronic pen.

3. The advertisement-providing device of claim 2, wherein the advertisement information includes one or more of a video advertisement, an advertisement through a web page, an image advertisement, and a voice advertisement.

4. The advertisement-providing device of claim 3, wherein the advertisement information further includes information on a position at which the image advertisement is posted.

5. The advertisement-providing device of claim 3, wherein the advertisement information further includes information on a time for which the voice advertisement is output.

6. The advertisement-providing device of claim 1, wherein the storage unit stores the writing data, the advertisement information corresponding to the writing data, and a keyword corresponding to the writing data as a group.

7. The advertisement-providing device of claim 6, further comprising a search unit configured to search for writing data and advertisement information grouped with a keyword.

8. The advertisement-providing device of claim 1, further comprising an advertisement information storage unit configured to store advertisement information for each piece of identification information of the electronic pen,
wherein the advertisement information extraction unit extracts the advertisement information from the advertisement information storage unit.

9. An advertising method using an electronic pen of an advertisement-providing device, the advertising method comprising:
receiving pattern information detected by the electronic pen on a recording medium on which a pattern is formed and identification information of the electronic pen;
converting the pattern information into writing data;
extracting advertisement information from the identification information;
storing the writing data and the advertisement information; and
transmitting the writing data and the advertisement information to a user terminal.

10. The advertising method of claim 9, wherein the writing data includes an image file including handwriting recorded on the recording medium by the electronic pen.

11. The advertising method of claim 10, wherein the advertisement information includes one or more of an image advertisement and a voice advertisement.
